(19) United States
(12) Patent Application Publication
(10) Pub. No.: US 2019/0301679 A1
(43) Pub. Date: Oct. 3, 2019

(54) DRY ICE COMPRESSOR DEVICE

(71) Applicant: Tokitae LLC, Bellevue, WA (US)

(72) Inventors: Stephen Thomas Graves Burkot, Seattle, WA (US); 3ric Johanson, Seattle, WA (US); Mark K. Kuiper, Seattle, WA (US); Daniel Howard Lieberman, Issaquah, WA (US); Lucas Wagner, Duvall, WA (US)

(73) Assignee: TOKITAE LLC, a limited liability company of the State of Delaware

(21) Appl. No.: 15/937,462

(22) Filed: Mar. 27, 2018

(51) Int. Cl. F17C 7/04

(52) U.S. Cl. CPC F17C 7/04

(57) ABSTRACT

Disclosed embodiments include apparatuses for compressing dry ice. In an illustrative embodiment, an apparatus for compressing dry ice includes: a hollow cylinder; a post disposed coaxially in the cylinder; a piston defining an opening therein and being slidably disposed in the cylinder, the opening slidably receiving the post therein; a biasing device operatively coupled to the piston; an inlet port connectable to a source of liquid carbon dioxide and configured to introduce liquid carbon dioxide into the cylinder, the inlet port being further configured to expand liquid carbon dioxide to dry ice and to gaseous carbon dioxide; and an openably closable lid positionable among a first closed position configured to vent gaseous carbon dioxide from the cylinder, a second closed position configured to leakably close the cylinder to permit carbon dioxide flakes to be compressed in the cylinder, and an open position.

### FIELD

The present disclosure relates to compressing dry ice flakes.

### BACKGROUND

In various cold chain applications, it is desirable to maintain products to be transported to remote locations at low temperatures for extended periods of time. For example, in some examples the product may include vaccines and/or bull semen (to be used for artificial insemination of dairy cattle). In such cases, lowering temperature of the product can help lower metabolic processing rate of the product and, in turn, can thereby help increase the likelihood that the product may be transported and delivered to a desired location while also remaining efficacious upon delivery.

In some currently-known applications, liquid nitrogen is used to lower temperature of some such products to temperatures that may accomplish some of the desired results discussed above.

However, in many locations, such as developing countries, liquid nitrogen is not readily available. Thus, challenges remain to producing sources—other than liquid nitrogen—of low temperatures that are readily available—such as dry ice—and that may endure for extended periods of transportation to a final destination.

### SUMMARY

Disclosed embodiments include apparatuses for compressing dry ice flakes. In various embodiments, the dry ice flakes are compressed in situ after their creation.

In an illustrative embodiment, an apparatus for compressing dry ice includes: a hollow cylinder; a post disposed coaxially in the cylinder; a piston defining an opening therein and being slidably disposed in the cylinder, the opening slidably receiving the post therein; a biasing device operatively coupled to the piston; an inlet port connectable to a source of liquid carbon dioxide and configured to introduce liquid carbon dioxide into the cylinder, the inlet port being further configured to expand liquid carbon dioxide to dry ice and to gaseous carbon dioxide; and an openably closable lid positionable among a first closed position configured to vent gaseous carbon dioxide from the cylinder, a second closed position configured to leakably close the cylinder to permit carbon dioxide flakes to be compressed in the cylinder, and an open position.

In another illustrative embodiment, an apparatus for compressing dry ice includes: a hollow cylinder; thermal insulation disposed in thermal communication with the cylinder;

a post disposed coaxially in the cylinder; a piston defining an opening therein and being slidably disposed in the cylinder, the opening slidably receiving the post therein; a biasing device operatively coupled to the piston; an inlet port defined in a sidewall of the cylinder and connectable to a source of liquid carbon dioxide, the inlet port being configured to introduce liquid carbon dioxide into the cylinder, the inlet port being further configured to expand liquid carbon dioxide to dry ice and to gaseous carbon dioxide; and an openably closable lid positionable among a first closed position configured to vent gaseous carbon dioxide from the cylinder, a second closed position configured to leakably close the cylinder to permit carbon dioxide flakes to be compressed in the cylinder, and an open position.

In another illustrative embodiment, an apparatus for compressing dry ice includes: a hollow cylinder; thermal insulation disposed in thermal communication with the cylinder; a post disposed coaxially in the cylinder; a piston defining an opening therein and being slidably disposed in the cylinder, the opening slidably receiving the post therein; a jack operatively coupled to the piston; an inlet port connectable to a source of liquid carbon dioxide and configured to introduce liquid carbon dioxide into the cylinder, the inlet port being further configured to expand liquid carbon dioxide to dry ice and to gaseous carbon dioxide; and an openably closable lid positionable among a first closed position configured to vent gaseous carbon dioxide from the cylinder, a second closed position configured to leakably close the cylinder to permit carbon dioxide flakes to be compressed in the cylinder, and an open position.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE FIGURES

FIG. 1A is a perspective view of an illustrative apparatus for compressing dry ice in a configuration for filling with liquid carbon dioxide and venting gaseous carbon dioxide.

FIG. 1B is a perspective view of the apparatus of FIG. 1A in a configuration for compressing dry ice flakes.

FIG. 1C is a perspective view of the apparatus of FIG. 1A in a configuration for removal of compressed dry ice.

FIG. 1D is a perspective view of another illustrative apparatus for compressing dry ice in a configuration for filling with liquid carbon dioxide and venting gaseous carbon dioxide.

FIG. 1E is a perspective view of the apparatus of FIG. 1D in a configuration for compressing dry ice flakes.

FIG. 1F is a perspective view of the apparatus of FIG. 1D in a configuration for removal of compressed dry ice.

FIG. 1G is a perspective view of another illustrative apparatus for compressing dry ice in a configuration for filling with liquid carbon dioxide and venting gaseous carbon dioxide.

FIG. 1I is a perspective view of the apparatus of FIG. 1G in a configuration for compressing dry ice flakes.

FIG. 1I is a perspective view of the apparatus of FIG. 1G in a configuration for removal of compressed dry ice.

FIG. 2A is a top plan view of the apparatus of FIG. 1A in a configuration for filling with liquid carbon dioxide and venting gaseous carbon dioxide.

FIG. 2B is a top plan view of the apparatus of FIG. 1A in a configuration for compressing dry ice flakes.

FIG. 2C is a top plan view of the apparatus of FIG. 1A in a configuration for removal of compressed dry ice.

FIG. 3A is a side plan view in cutaway of the apparatus of FIGS. 1A-1I in a configuration for filling with liquid carbon dioxide and venting gaseous carbon dioxide.

FIG. 3B is a side plan view in cutaway of the apparatus of FIGS. 1A-1I in a configuration for compressing dry ice flakes.

FIG. 3C is a side plan view in cutaway of an illustrative apparatus for compressing dry ice in a configuration for compressing dry ice flakes.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

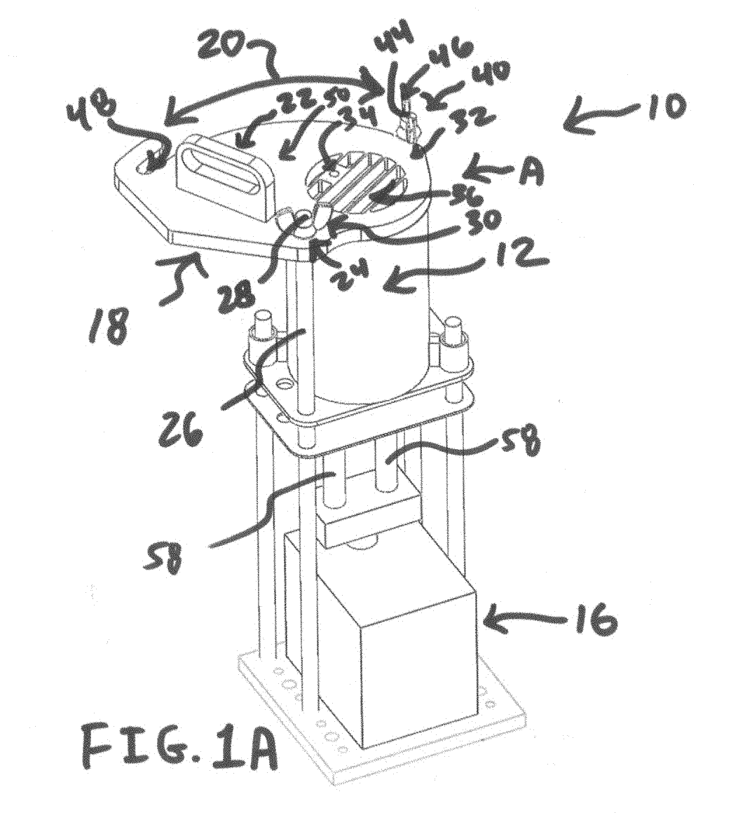

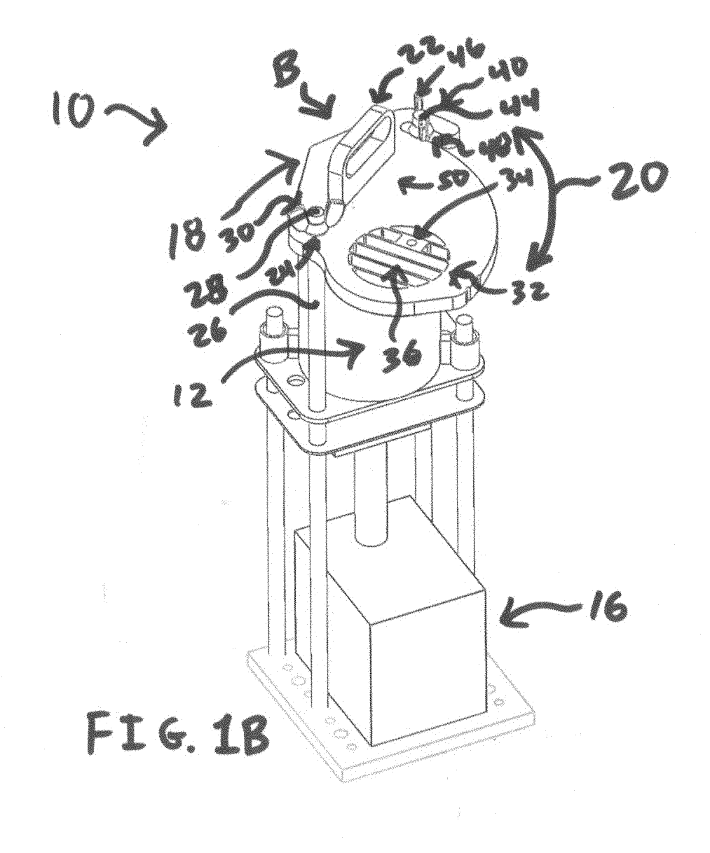

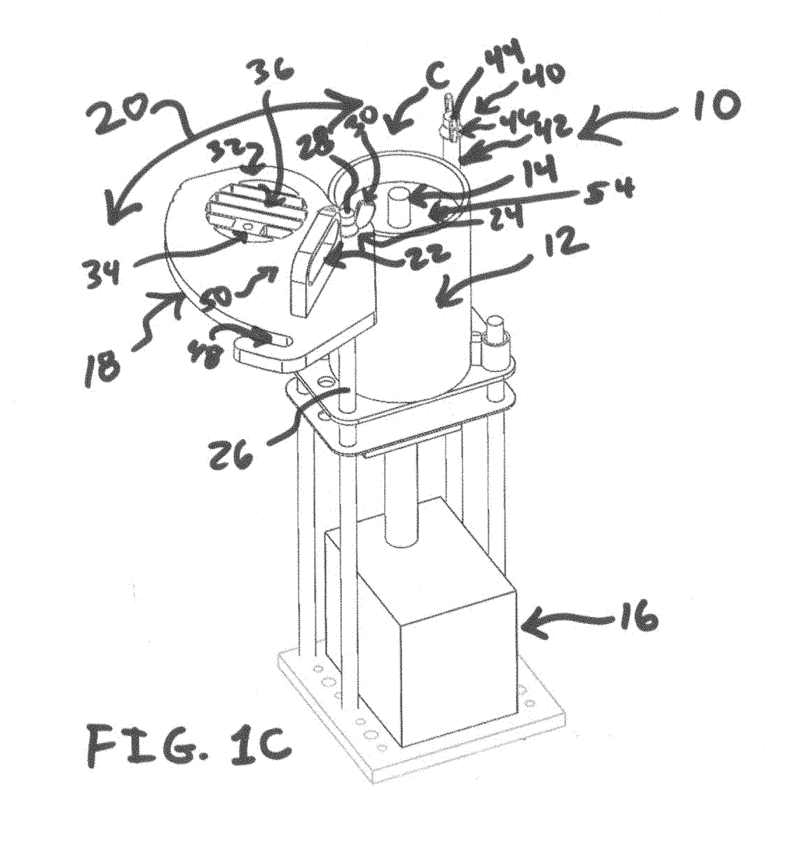

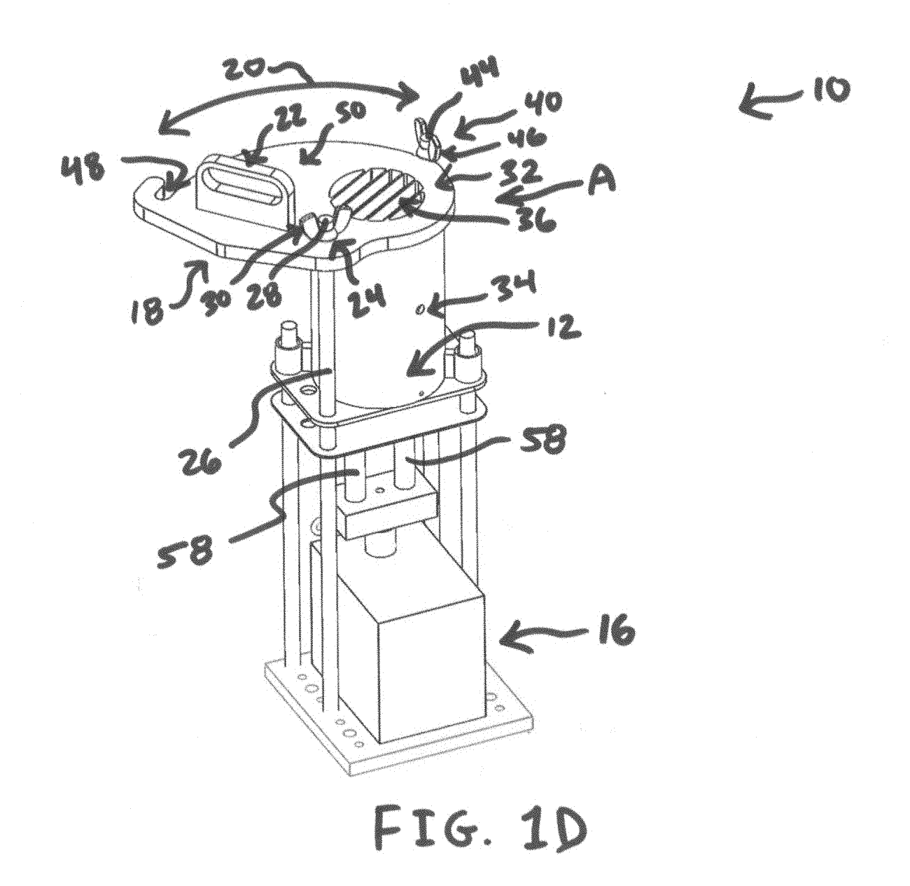

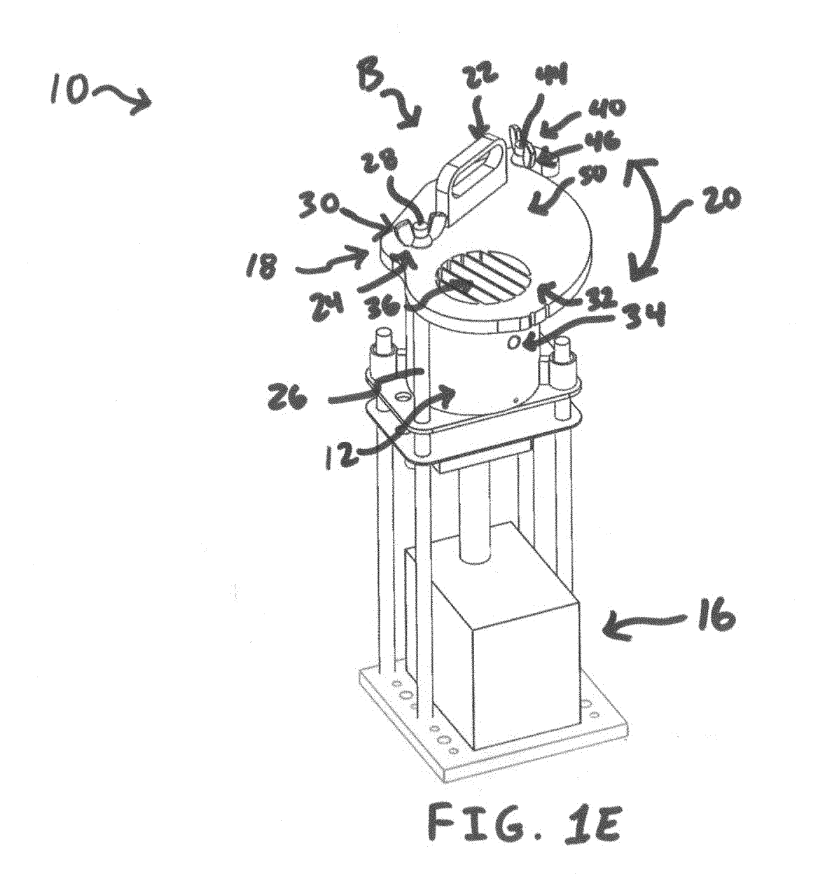

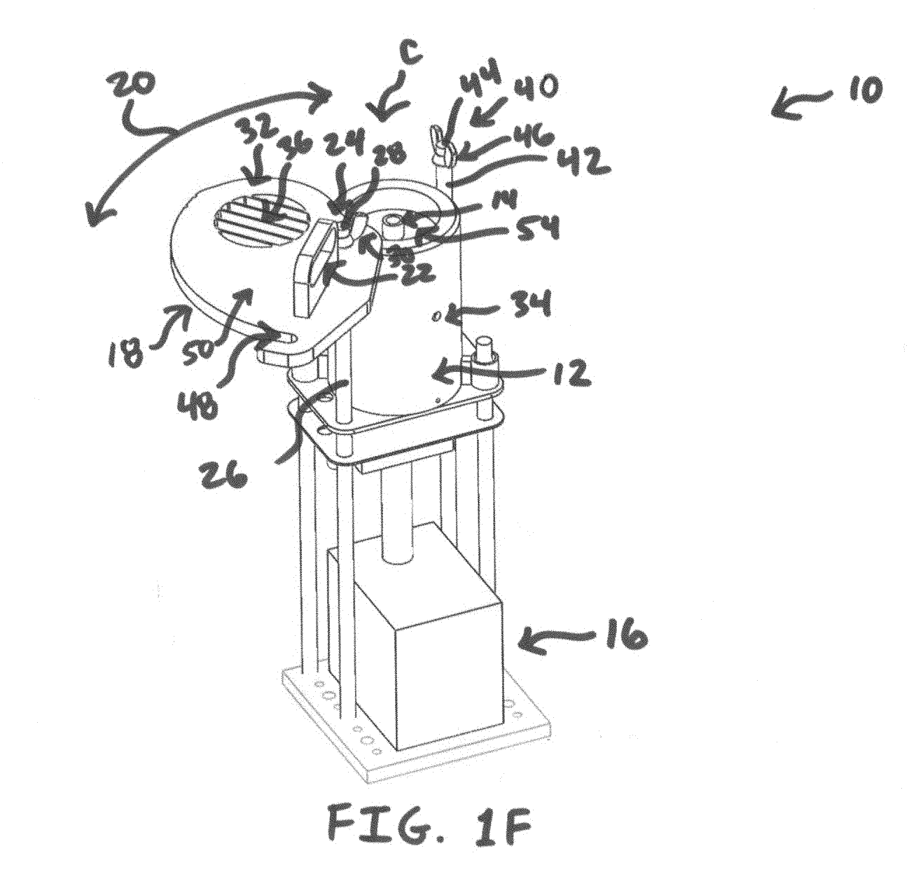

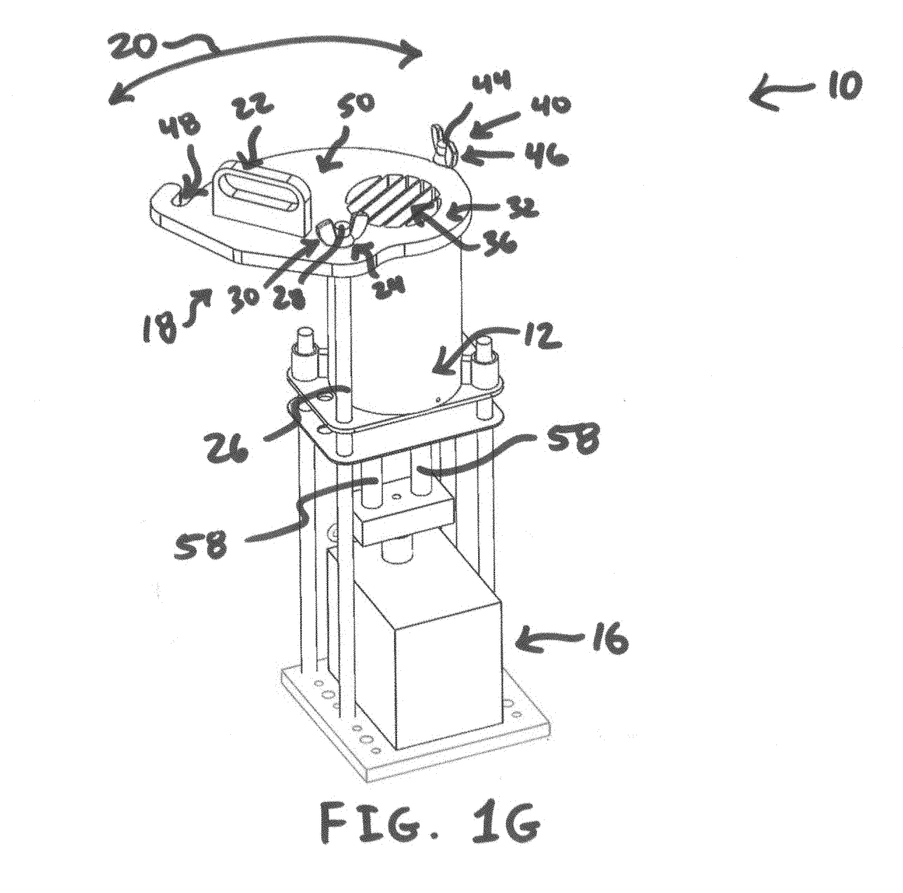

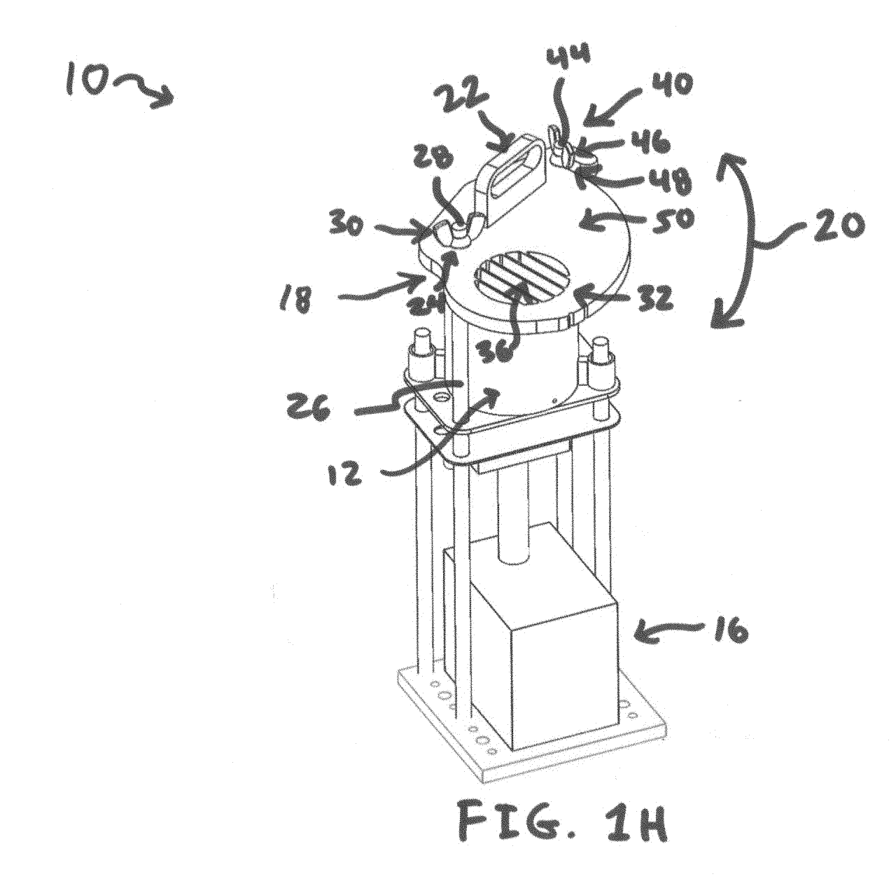

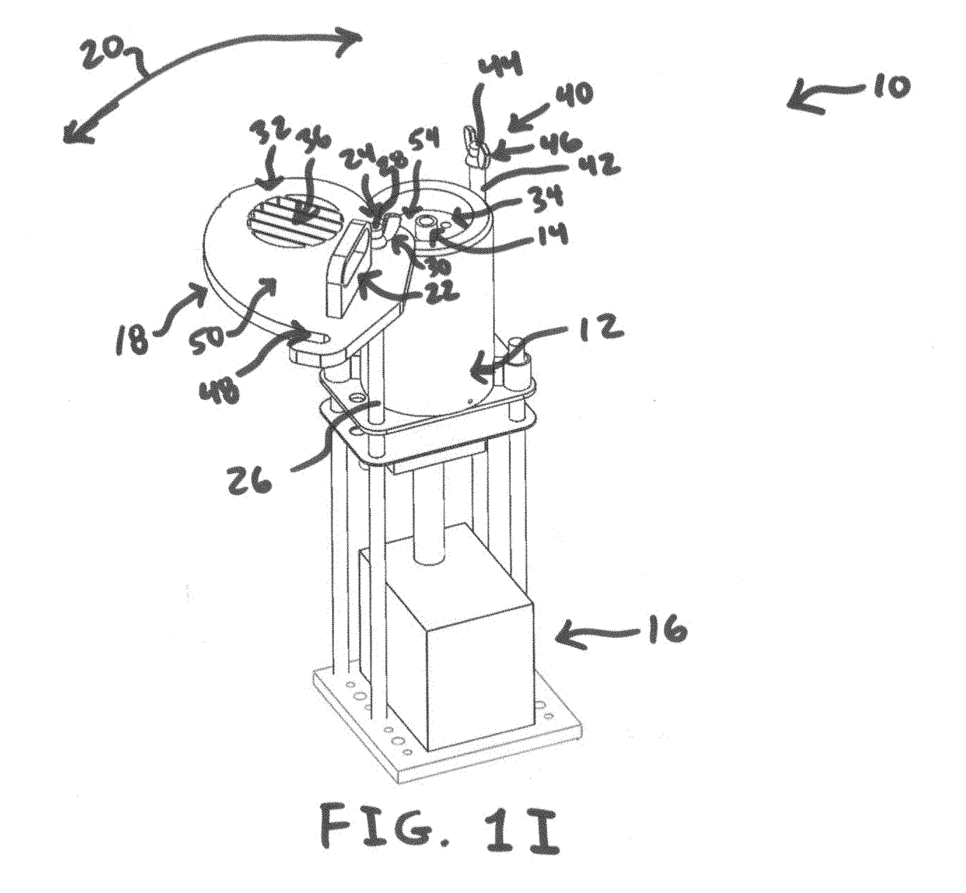

Referring to FIGS. 1A, 1B, and 1C and given by way of overview, in an illustrative embodiment an apparatus 10 for compressing dry ice includes a hollow cylinder 12. A post 14 (FIG. 1C) is disposed coaxially in the cylinder 12. A piston 54 (FIG. 1C) defines an opening (not shown in FIGS. 1A-1C) therein and is slidably disposed in the cylinder 12. The opening slidably receives the post 14 therein. A biasing device 16 is operatively coupled to the piston 54. An inlet port 34 is connectable to a source of liquid carbon dioxide (not shown) and is configured to introduce liquid carbon dioxide into the cylinder 12. The inlet port 34 is further configured to expand (that is, flash) liquid carbon dioxide to dry ice and to gaseous carbon dioxide. An openably closable lid 18 is positionable (as indicated by an arrow 20) among a first closed position A (FIG. 1A) configured to vent gaseous carbon dioxide from the cylinder 12, a second closed position B (FIG. 1B) configured to leakably close the cylinder 12 to permit carbon dioxide flakes to be compressed in the cylinder 12, and an open position C (FIG. 1C).

Referring to FIGS. 1D, 1E, and 1F and still by way of overview, in another illustrative embodiment the apparatus 10 is similar to that shown in FIGS. 1A, 1B, and 1C, except that the inlet port 34 is defined in a side wall of the cylinder 12 (instead of being defined in the lid 18 as shown in FIGS. 1A, 1B, and 1C).

Referring to FIGS. 1G, 1H, and 1I and still by way of overview, in another illustrative embodiment the apparatus 10 is similar to that shown in FIGS. 1A, 1B, and 1C, except that the inlet port 34 is defined in the piston 54 (instead of being defined in the lid 18 as shown in FIGS. 1A, 1B, and 1C).

Now that an overview has been given, details of various embodiments will be explained below by way of examples provided by way of illustration only and not of limitation.

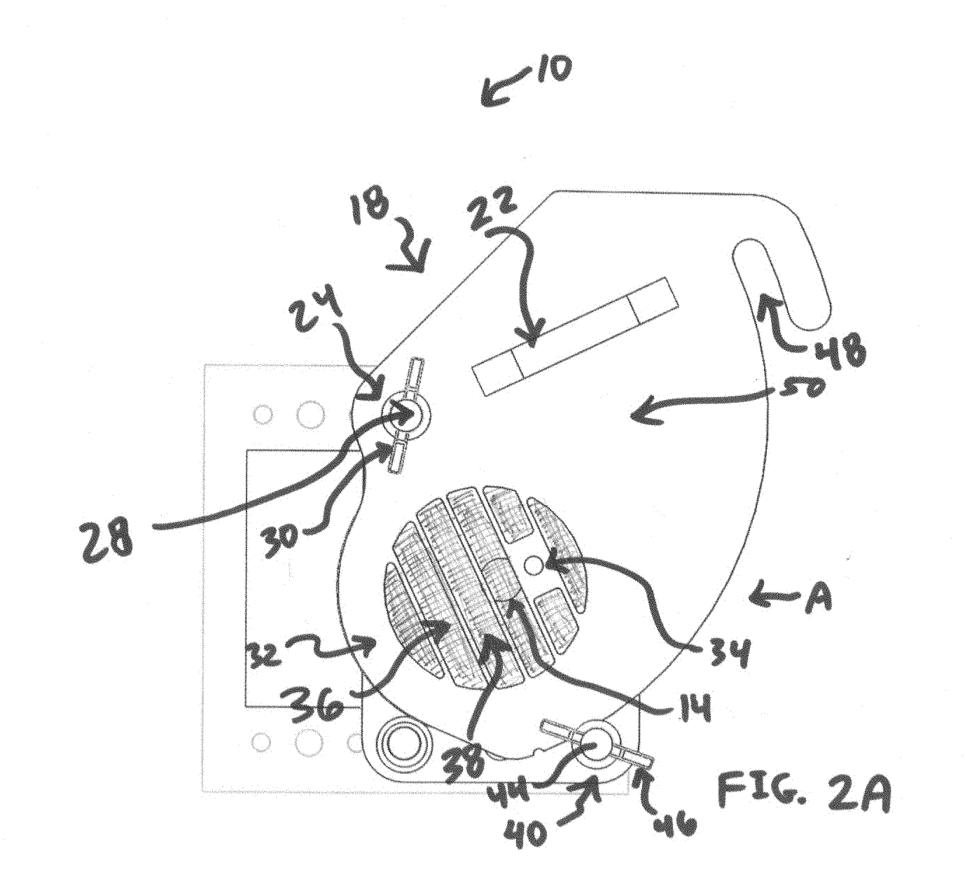

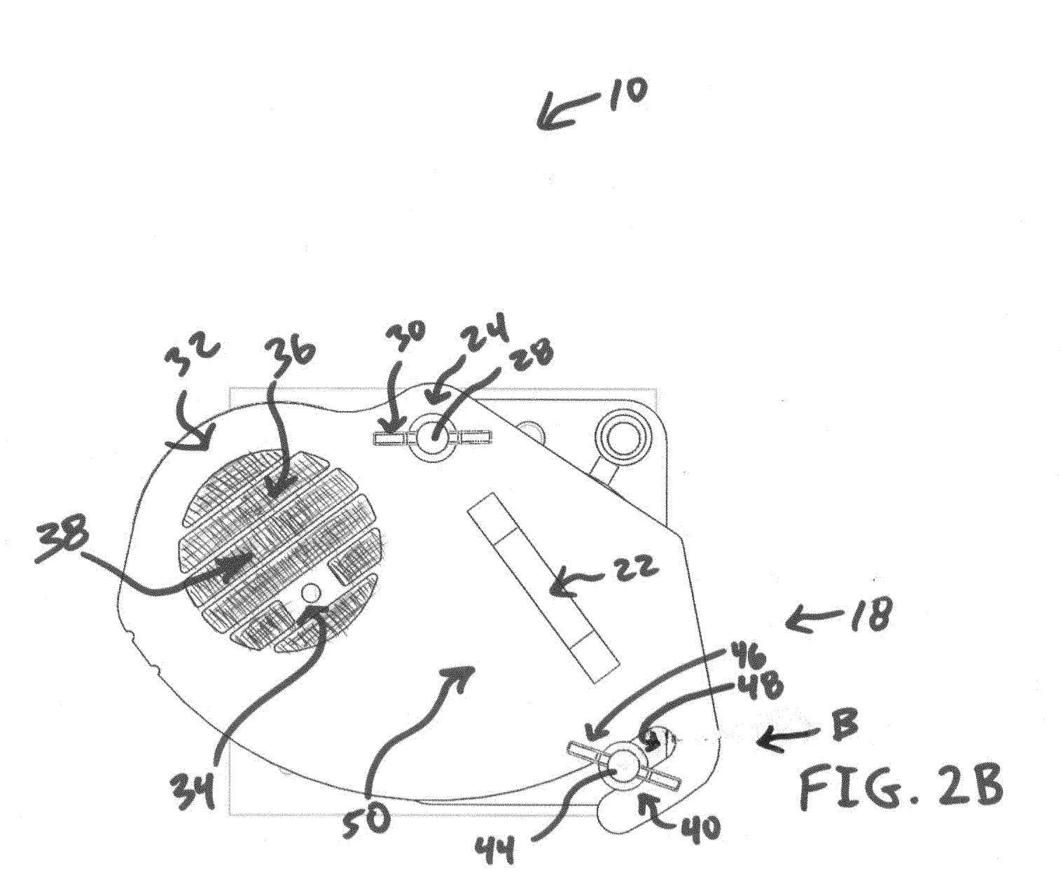

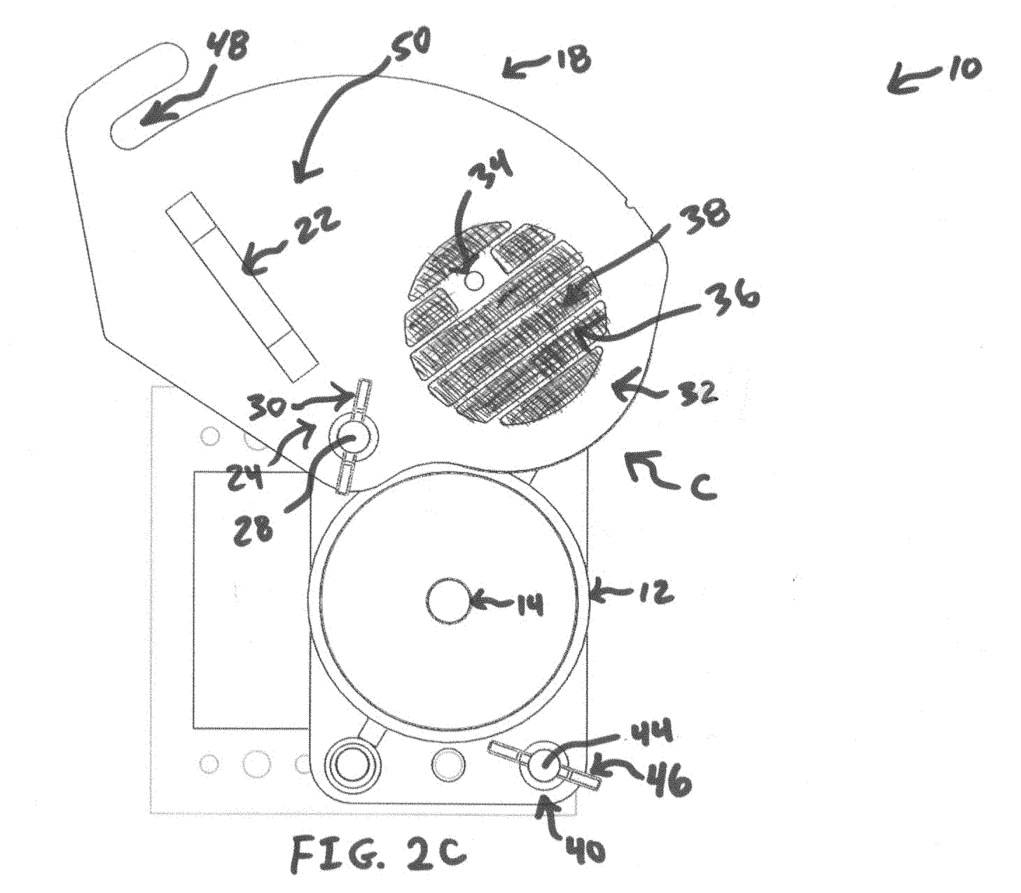

Referring additionally to FIGS. 2A, 2B, and 2C and as mentioned above, in various embodiments the lid 18 is positioned in positions A, B, and C, respectively. Illustrative, non-limiting details regarding the lid 18 and the positions A, B, and C will be set forth below.

Regarding construction materials, in various embodiments the cylinder 12 and the lid 18 suitably are made from materials that are able to withstand loads imparted during compression of dry ice in the cylinder 12. For example and without limitation, in various embodiments the cylinder 12 and the lid 18 suitably may be made from steel, such as plain carbon steel or any suitable stainless steel, as desired. It will be appreciated that neither the cylinder 12 nor the lid 18 need be made from stainless steel.

The lid 18 includes a handle 22. The handle 22 is configured to permit a user to grab and then position the lid 18 among the positions A, B, and C by pivoting the lid 18 in directions indicated by the arrow 20 (FIGS. 1A-1C).

The lid 18 is pivotable about a pivot point 24. A pivot hole (not shown) is defined in the lid 18, thereby providing the pivot point 24. A support post 26 (FIGS. 1A-1C) has a threaded rod 28 that extends from a top end of the support post 26. A diameter of the support post 26 is greater than a diameter of the pivot hole, such that the lid 18 is supportable on the support post 26. A diameter of the threaded rod 28 is less than the diameter of the pivot hole. The threaded rod 28 is received inside the pivot hole, and the lid 18 is supported by the support post 26. A suitable threaded connector 30, such as a wing nut, threadedly engages the threaded rod 28 and pivotably retains the lid 18 in place against a top surface of the support post 26.

In various embodiments the lid 18 includes a portion 32. In some embodiments and as shown in FIGS. 1A-1C and 2A-2C, the portion 32 defines at least one opening therein that is a fill orifice that is configured as the inlet port 34. Given by way of non-limiting example, the opening of the inlet port 34 may have a diameter of between around 0.031 inches—to around 0.125 inches and effect expansion (that is, flashing) of liquid carbon dioxide to dry ice and to gaseous carbon dioxide. It will be appreciated that, in some embodiments, more than one opening for the inlet port 34 may be provided, as desired, to help increase efficiency of the apparatus 10.

In some other embodiments and as discussed above, the inlet port is not provided in the lid 18. Instead, in some of these embodiments the inlet port 34 is defined in a side wall of the cylinder 12 (FIGS. 1D-1F) and in some other of these embodiments the inlet port 34 is defined in the piston 54 (FIGS. 1G-1I). It will be appreciated that, except for location of the inlet port 34, all other details of the apparatus 10 (and its operation) are the same for the various embodiments shown in FIGS. 1A-1C, FIGS. 1D-1F, and FIGS. 1G-1I.

In various embodiments, the portion 32 further defines an opening 36 therein. The opening 36 is configured to permit gaseous carbon dioxide (formed when liquid carbon dioxide has been expanded) to exit the cylinder 12. In various embodiments, a porous screen 38 covers the opening 36. The screen 38 defines a mesh that is sized to prevent dry ice flakes from escaping the cylinder 12 but to permit gaseous carbon dioxide to escape the cylinder 12 upon expansion of liquid carbon dioxide through the inlet port 34. The screen 38 may be attached to an underside of the lid 18, if desired, to help prevent dry ice flakes from entering the opening 36.

The lid 18 is latchable about a latch point 40. A latch hole (not shown) is defined in the lid 18, thereby providing the latch point 40. A support post 42 (FIG. 1C) has a threaded rod 44 that extends from a top end of the support post 42. A diameter of the support post 42 is greater than a diameter of the latch hole, such that the lid 18 is supportable on the support post 42. A diameter of the threaded rod 44 is less than the diameter of the latch hole. The threaded rod 44 is received inside the latch hole, and the lid 18 is supported by the support post 42. A suitable threaded connector 46, such as a wing nut, threadedly engages the threaded rod 44 and retains the lid 18 in place against the top surface of the support post 42. An elongate cutout 48 is defined in the lid 18. The cutout has a width sized to receive the threaded rod 44 therein.

When it is desired to fill the cylinder 12 with liquid carbon dioxide and vent gaseous carbon dioxide from the cylinder 12, the portion 32 of the lid 18 is positioned over the cylinder 12 in the position A (FIGS. 1A and 2A). When it is desired to compress dry ice flakes, the lid 18 is pivoted about the pivot point 24 until the threaded rod 44 is received in the elongate cutout 48 and a solid portion 50 of the lid 18 is positioned over the cylinder 12 in the position B (FIGS. 1B and 2B). When it is desired to remove compressed dry ice from the cylinder 12, the lid 12 is pivoted about the pivot point 24 until the lid 18 is clear of the cylinder 18 in the position C (FIGS. 1C and 2C).

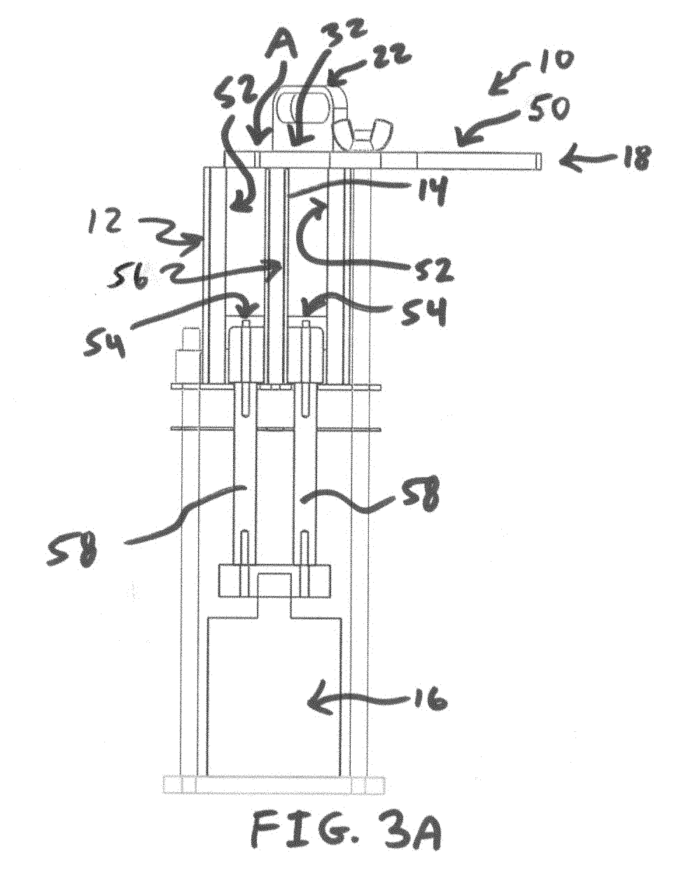

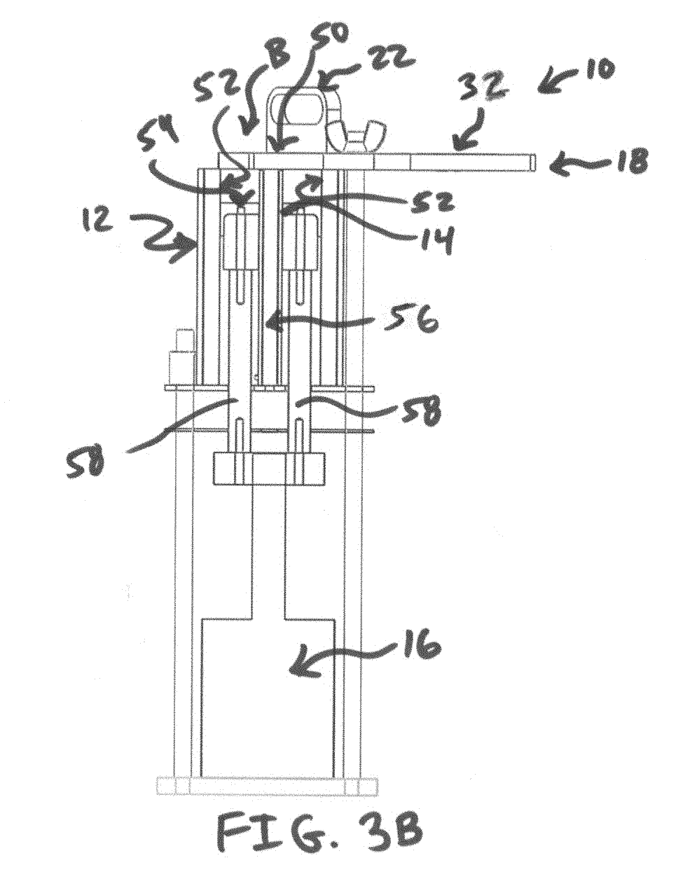

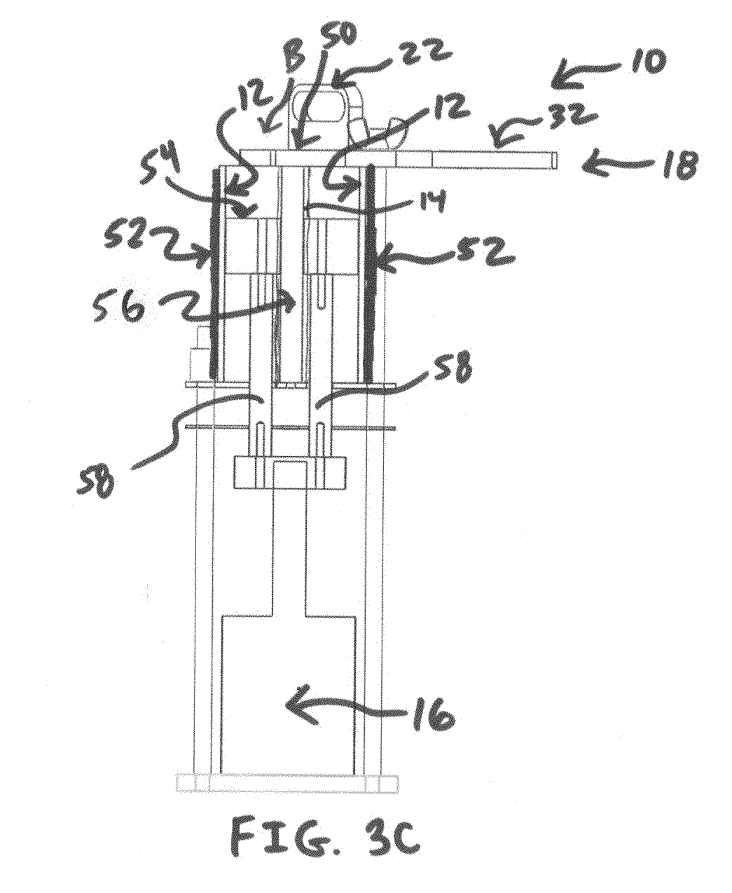

As is known, at atmospheric pressure the temperature of dry ice is around −78.5° C. (−109.3° F.) or 194.65K. Therefore, in various embodiments and referring additionally to FIGS. 3A, 3B and 3C, it will be appreciated that thermal insulation 52 may be disposed in thermal communication with the cylinder 12, if desired.

In some such embodiments and as shown in FIGS. 3A and 3B, the thermal insulation 52 is disposed on an interior surface of the cylinder 12. In some such embodiments, the thermal insulation 52 may include a plastic liner.

In some other such embodiments and as shown in FIG. 3C, the thermal insulation 52 is disposed on an exterior surface of the cylinder 12. In such embodiments the thermal insulation 52 may include any suitable thermal insulation material as desired.

In various embodiments, a diameter of the post 14 suitably may be sized to define a cylindrical (that is, tube-shaped) hole in a compressed dry ice product. In some embodiments, several of the compressed dry ice products may be disposed in a thermally-insulated container in a vertically-stacked manner, thereby defining a vertically-elongated, cylindrical, tube-shaped hole. In some such instances and given by way of illustrative, non-limiting example, artificial insemination straws containing bull semen may be disposed within a canister that is placed within the vertically-elongated, cylindrical, tube-shaped hole. However, other items, such as vaccines or the like, may be disposed within the vertically-elongated, cylindrical, tube-shaped hole, as desired for a particular application. In some of these embodiments the opening in the piston may be centrally-located. As a result, in such embodiments, the post 14 suitably is centrally-located and, as a result, the tube-shaped holed in the compressed dry ice is also centrally-located. In some other of these embodiments the opening in the piston is not centrally-located but is offset. As a result, in such embodiments, the post 14 suitably is offset and, as a result, the tube-shaped holed in the compressed dry ice is also offset.

In various embodiments, the biasing device 16 may include a jack, such as without limitation a bottle jack or the like. In such embodiments, the jack may be operable by motive force provided from a user and/or a pneumatic source. In some such embodiments, the pneumatic source may include the source of liquid carbon dioxide, which may be pressurized on the order of around 350 psig+/−50 psig or so.

In various embodiments and as shown in FIGS. 3A-3C, as mentioned above a piston 54 defines an opening 56 therein and is slidably disposed in the cylinder 12. The opening 56 slidably receives the post 14 therein. As discussed above, in some embodiments the opening 56 may be centrally-located and in some other embodiments the opening 56 may be offset. The biasing device 16 is operatively coupled to the piston 54, such as via connecting push rods 58. It will be appreciated that, in various embodiments, at least two push rods 58 are provided in order to accommodate the post 14 therein.

Referring to FIGS. 1A-1I, 2A-2C, and 3A-3C, various embodiments of the apparatus 10 operate as follows.

As shown in FIGS. 1A, 1D, 1G, 2A, and 3A, the lid 18 is placed in the position A. The threaded connectors 30 and 46 are tightened to secure in place the lid 18. A source (not shown) of liquid carbon dioxide (which may be pressurized on the order of around 350 psig +/−50 psig or so) is pneumatically coupled to the inlet port 34. If desired, in some embodiments the source of liquid carbon dioxide may be pneumatically coupled to the inlet port 34 and then the lid 18 is placed and secured in the position A. Liquid carbon dioxide is provided from the source of liquid carbon dioxide to the apparatus 10, and is expanded (flashed) to dry ice flakes and gaseous carbon dioxide. The gaseous carbon dioxide (formed when liquid carbon dioxide has been expanded through the opening of the inlet port 34) exits the cylinder 12 via openings in the mesh in the porous screen 38 that covers the opening 36. The screen 38 prevents the dry ice flakes from escaping the cylinder 12 upon expansion of the liquid carbon dioxide through the opening of the inlet port 34. It will be appreciated that position of the screen 38 and size of openings in the mesh may be selected as desired for a particular application based upon factors such as, without limitation, safety of a user and minimizing gas flow in direction of a user.

The threaded connectors 30 and 46 are loosened, and the lid 18 is pivotally positioned from the position A to the position B (FIGS. 1B, 1E, 1H, 2B, and 3B). The threaded connectors 30 and 46 are tightened. The biasing device 16 is engaged to urge the piston 54 upwardly toward the lid 18, thereby compressing the dry ice flakes into a dry ice product that defines therein an opening such as that defined by the opening 56. As discussed above, the biasing device 16 may be operable by motive force provided from a user and/or a pneumatic source, such as the source of liquid carbon dioxide. It will be appreciated that, in various embodiments, the cylinder 12 may be leakably closed. That is, in such embodiments solid, liquid, and/or gaseous carbon dioxide can escape the cylinder 12 in a void that may be formed between the cylinder 12 and the lid 18 while (and after) the dry ice flakes are compressed, thereby helping to reduce and/or prevent an undesirable rise in pressure within the cylinder 12 during compression of the dry ice flakes.

After the dry ice product has been compressed, the threaded connectors 30 and 46 are loosened, and the lid 18 is pivotally positioned from the position B to the position C (FIGS. 1C, 1F, 1I, 2C, and 3C). The biasing member 16 may be engaged to urge the piston 54 upwardly, thereby upwardly urging the dry ice product until the dry ice product may be removed from the cylinder 12.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An apparatus for compressing dry ice, the apparatus comprising:
a hollow cylinder;
a post disposed coaxially in the cylinder;
a piston defining an opening therein and being slidably disposed in the cylinder, the opening slidably receiving the post therein;
a biasing device operatively coupled to the piston;
an inlet port connectable to a source of liquid carbon dioxide and configured to introduce liquid carbon dioxide into the cylinder, the inlet port being further configured to expand liquid carbon dioxide to dry ice and to gaseous carbon dioxide; and
an openably closable lid positionable among a first closed position configured to vent gaseous carbon dioxide from the cylinder, a second closed position configured to leakably close the cylinder to permit carbon dioxide flakes to be compressed in the cylinder, and an open position.

2. The apparatus of claim 1, further comprising:
thermal insulation disposed in thermal communication with the cylinder.

3. The apparatus of claim 2, wherein the thermal insulation is disposed on an interior surface of the cylinder.

4. The apparatus of claim 3, wherein the thermal insulation includes a plastic liner.

5. The apparatus of claim 2, wherein the thermal insulation is disposed on an exterior surface of the cylinder.

6. The apparatus of claim 1, wherein the lid includes a first portion, the first portion defining at least one first opening therein configured as the inlet port, the first portion further defining a second opening therein configured to vent gaseous carbon dioxide from the cylinder.

7. The apparatus of claim 6, wherein the lid includes a screen that covers the second opening.

8. The apparatus of claim 1, wherein the biasing device includes a jack.

9. The apparatus of claim 8, wherein the jack is operable by motive force provided from a source chosen from a user and a pneumatic source.

10. The apparatus of claim 1, wherein a wall of the cylinder defines an opening therein configured as the inlet port.

11. The apparatus of claim 1, wherein the piston defines an opening therein configured as the inlet port.

12. An apparatus for compressing dry ice, the apparatus comprising:
a hollow cylinder;
thermal insulation disposed in thermal communication with the cylinder;
a post disposed coaxially in the cylinder;
a piston defining an opening therein and being slidably disposed in the cylinder, the opening slidably receiving the post therein;
a biasing device operatively coupled to the piston;
an inlet port defined in a sidewall of the cylinder and connectable to a source of liquid carbon dioxide, the inlet port being configured to introduce liquid carbon dioxide into the cylinder, the inlet port being further configured to expand liquid carbon dioxide to dry ice and to gaseous carbon dioxide; and
an openably closable lid positionable among a first closed position configured to vent gaseous carbon dioxide from the cylinder, a second closed position configured to leakably close the cylinder to permit carbon dioxide flakes to be compressed in the cylinder, and an open position.

13. The apparatus of claim 12, wherein the thermal insulation is disposed on an interior surface of the cylinder.

14. The apparatus of claim 13, wherein the thermal insulation includes a plastic liner.

15. The apparatus of claim 12, wherein the thermal insulation is disposed on an exterior surface of the cylinder.

16. The apparatus of claim 12, wherein the lid includes a first portion, the first portion defining an opening therein configured to permit gaseous carbon dioxide to exit the cylinder.

17. The apparatus of claim 16, wherein the lid includes a screen that covers the opening.

18. The apparatus of claim 12, wherein the biasing device includes a jack.

19. The apparatus of claim 18, wherein the jack is operable by motive force provided from a source chosen from a user and a pneumatic source.

20. An apparatus for compressing dry ice, the apparatus comprising:
a hollow cylinder;
thermal insulation disposed in thermal communication with the cylinder;
a post disposed coaxially in the cylinder;
a piston defining an opening therein and being slidably disposed in the cylinder, the opening slidably receiving the post therein;
a jack operatively coupled to the piston;
an inlet port connectable to a source of liquid carbon dioxide and configured to introduce liquid carbon dioxide into the cylinder, the inlet port being further configured to expand liquid carbon dioxide to dry ice and to gaseous carbon dioxide; and
an openably closable lid positionable among a first closed position configured to vent gaseous carbon dioxide from the cylinder, a second closed position configured to leakably close the cylinder to permit carbon dioxide flakes to be compressed in the cylinder, and an open position.

21. The apparatus of claim 20, wherein the lid includes a first portion, the first portion defining at least one first opening therein configured as the inlet port, the first portion further defining a second opening therein configured to vent gaseous carbon dioxide from the cylinder.

22. The apparatus of claim 20, wherein the lid includes a screen that covers the second opening.

23. The apparatus of claim 20, wherein a wall of the cylinder defines an opening therein configured as the inlet port.

24. The apparatus of claim 20, wherein the piston defines an opening therein configured as the inlet port.
